(19) United States
(12) Patent Application Publication
(10) Pub. No.: US 2012/0085018 A1
(43) Pub. Date: Apr. 12, 2012

(54) Elasmobranch-repelling magneto-electropositive fishing hook

(76) Inventor: Eric Matthew Stroud, Oak Ridge, NJ (US)

(21) Appl. No.: 12/925,065

(22) Filed: Oct. 12, 2010

(51) Int. Cl. A01K 83/00

(52) U.S. Cl. 43/43.16

(57) ABSTRACT

A fishing hook with elasmobranch-repelling qualities is disclosed. The fishing hook, comprised of a ferromagnetic material, is rendered repellent to elasmobranchs through the incorporation of an exterior coating of an electropositive metal, and contact or impulse magnetization.

### SUMMARY OF THE INVENTION

The present invention is a magneto-electropositive fishing hook. More specifically, the invention is a fishing hook comprised of a magnetized ferromagnetic material and coated with an electropositive metal that is used to intentionally reduce elasmobranch interactions with the hook.

### BACKGROUND OF THE INVENTION

Pelagic longlining fishing is an open-ocean technique that employs a long mainline from which individual hooks are suspended at various depths depending on the target species. The hooks are attached to the main line by monofilament branch lines called gangions or “snoods”. Floats are attached to the mainline at regular intervals to keep it elevated horizontally in the water column. A variety of bait types are employed, including whole small fish, Atlantic mackerel and squid, to name a few. Luminescent light sticks are often fastened to the gangions near the baited hooks, making them more attractive to the targeted species and also attracting smaller species on which targeted species feed. The longlines used by the United States domestic pelagic longline fleet range from 20 to 40 miles in length. The depth at which the hooks are set is controlled by the length of the lines attaching the main line to the floats, by the length of the gangions, and by the speed at which the longline gear is set. After a variable “soak time,” the gear is retrieved, and the catch is brought on board for cleaning and icing down in the hold. This “one at a time” processing and handling gives longline products a high quality distinction in the marketplace.

Pelagic shark species such as the blue shark (Prionace glauca) are often attracted to miles of attractive stimuli resulting from the longlines. Shark interactions on pelagic longlines result in substantial inconveniences and adverse economic effects to fishers (Gilman, Clarke, Brothers, Alfaro-Shigueto, Mandelman, Mangel, Petersen, Piovano, Thomson, Dalzell, Donoso, Goren, Werner, 2007). In fisheries with restrictions on shark-finning, a lack of market for shark meat, or a per-trip limit on shark retention, shark interactions cause the following:
Reduced catch of marketable species: When baited hooks are occupied by sharks (referred to as “bycatch”) or removed by sharks, there are fewer hooks available to catch marketable target species;
Damage and loss of fishing gear: Sharks bite off terminal tackle (e.g., baited hook, leader, weighted swivel, and line) from branch lines, stretch and chafe branch lines, break the main line, and some shark species will pull the gear down causing branch lines to become entangled often resulting in large quantities of unusable fishing gear;
Risk of injury: It is dangerous for crew to handle caught sharks. There is a risk of being bitten or hit by weights when branch lines containing sharks snap during gear retrieval; and,
Expenditure of time. A majority of fishers consider the time required to remove sharks from gear, retrieve terminal tackle and repair and replace gear as a central concern resulting from shark interactions.

Responding to this problem, the inventors developed and commercialized two repellent materials which show selective shark repellent abilities for fisheries: Ferromagnets and electropositive metals. Both materials affect the electrosensitive ampullae of Lorenzini organ found only in sharks, as discussed below.

Elasmobranch fishes (sharks and rays) geolocate using magnetoreception, a method used by a wide variety of marine and terrestrial organisms (Kalmijn, 1973, 1974, 1982, 1984; Phillips, 1986; Carey and Scharold, 1990; Klimley, 1993; Wiltschko and Wiltschko, 1995; Holland et al. 1999). Organisms that employ magnetoreception typically gather information while in motion about geomagnetic parameters such as field intensity and the angle of inclination (Skiles, 1985).

There are three primary ways in which an animal perceives the Earth's magnetic field: (1) magnetite-based magnetoreception (Kirschvink et al., 2001; Wiltschko et al., 2002) (2) chemical magnetoreception (Ritz et al., 2000), and (3) indirect magnetoreception via electromagnetic induction (Kalmijn, 1982, 1984; Johnsen and Lohmann, 2005). Previous studies hypothesized that elasmobranchs perceive the Earth's geomagnetic fields through indirect magnetoreception via electromagnetic induction, and they use this locational information to navigate within coastal and pelagic environments (Kalmijn 1973, 1974, 1982, 1984; Carey and Scharold, 1990; Klimley 1993; Holland et al. 1999).

To understand how the process of electromagnetic induction aids elasmobranchs in navigation, it is essential to understand the law of electromagnetic induction proposed by Faraday. The law states that the electromotive force induced in a circuit is directly proportional to the time rate of change of magnetic flux through the circuit. An application of this law employs the classic example of a simple generator (i.e. a coil conductor and a permanent magnet) to demonstrate how the movement of the permanent magnet induces a measurable electromotive force. As a magnetic dipole approaches the coil, the magnetic field exerts an electromotive force on the electrons within the coil, producing an electrical current. For example, on a molecular level, a permanent ferromagnetic material such as Barium-ferrite contains a greater-than-average number of magnetic domains oriented in the same direction, and within each domain, unpaired electrons have their spin aligned in the same direction. The resulting magnetic flux from the permanent magnet induces the movement of electrons in the coil/conductor creating measurable voltages and current.

A similar phenomenon occurs when an animal swims through a magnetic (or geomagnetic) field. Electromagnetic induction occurs as an animal swims through the geomagnetic field emanating from the center of the earth, which ranges from 0.25-0.65 gauss. The geomagnetic flux causes the free electrons found within an organism's body (similar to a conductive coil) to move, creating an induced voltage and current within the shark.

Hypothetically, elasmobranchs can perceive the induced voltages, using their acute electrosensory organ known as the ampullae of Lorenzini (Kalmijn, 1966, 1971, 1974, 1984). The electric potential created by the geomagnetic field is different than that of the electric potential found within the conductive gel of the ampullae. The difference in electric potentials initiates the transmission of a signal sent via the afferent neurons to the central nervous system of the elasmobranch. Multiple ampullae distributed across the cephalic (nose) region of the elasmobranch are able to detect the minute differences in the Earth's geomagnetic field enabling the organism to determine its relative geolocation. Studies of the swimming behavior of blue sharks (Prionace glauca; Scharold, 1990) and scalloped hammerheads (Sphyrna lewini, Klimley, 1993) concluded that their directional movement within the referenceless pelagic environment must involve some compass-like mechanism, although the physiological basis for such a mechanism was not described at that time. Meyer et al. (2005) exposed scalloped hammerheads (Sphyrna lewini) and sandbar sharks (Carcharhinus plumbeus) to weak electromagnetic fields (maximum field strength 100 μT), which altered their feeding behavior. This study supported the hypothesis that the ampullae of Lorenzini, a network of gel-filled canals on the head of elasmobranchs which detects electric fields in the final stages of prey capture (Kalmijn, 1971; Kajiura and Holland, 2002, Kajiura, 2003) are also capable of detecting magnetic fields relatively close to that of the Earth's geomagnetic field. The ampullae are essentially low frequency voltmeters, allowing elasmobranchs to detect low frequency electric stimuli, i.e. less than 5 nV/cm in uniform fields and as low as 1 nV/cm in dipole fields Kalmijn 1966, 1971, 1974, 1982; Kajiura 2003; Peters 2007).

O'Connell (2007, 2008, 2009) found that for nurse sharks (Ginglymostoma cirratum) and southern stingrays (Dasyatis americana), the behavior towards a permanent magnet apparatus was dependant on the treatment type. In the presence of permanent magnets, D. americana and G. cirratum demonstrated a significantly greater number of avoidance behaviors towards the magnet side of the apparatus, while both species fed a significantly greater number of times from the procedural (nonmagnetic) control side. These results suggest that the species tested in this experiment were sensitive to these magnets and were successfully repelled from baited areas containing magnets.

On May 1, 2006, SharkDefense discovered that highly electropositive metals (EPMs)—metallic elements towards the left side of the periodic table—particularly early-Lanthanide or “rare earth” metals, induced deterrent behavior in juvenile lemon (Negaprion brevirostris) and nurse (Ginglymostoma cirratum) sharks. Subsequent to this discovery, SharkDefense applied for patents in the United States and Canada, which are currently pending. Not all seawater-corrodible metals, such a copper and zinc, are suitable as shark repellent EPMs. Shark repellency is a function of the standard reduction potential available from the metal in basic seawater electrolyte, relative to a shark's skin. The standard cell potential, E₀, between the metal and shark skin must be 0.8 eV or greater. If a shark skin reference electrode is not available, a carbon electrode may be substituted. An electromotive force in a standard seawater (pH=8.1) electrolyte with a carbon-metal electrode spacing of at least 0.01 m should yield at least 0.5 eV, indicating satisfactory shark repellent. A standard cell potential is calculated from the half-cell reactions for the metal and the electrolyte. For example, the standard reduction potential of zinc metal in basic electrolyte is 1.246 eV. Adding the −0.828 eV reduction for water, the standard cell potential is +0.418 eV. Zinc metal is not an effective shark repellent. By comparison, the standard reduction potential for yttrium metal (a trivalent EPM and confirmed shark repellent), is 2.85 eV, giving a standard cell potential of 2.022 eV (Bard, 1985). This corresponds closely to actual measurements made with yttrium metal and a shark fin clipping electrode in pH=8.1 seawater at 25° C.

In response to the discovery several National Oceanographic and Atmospheric Administration (NOAA), academic and private sector researchers conducted various experiments to evaluate the efficacy of employing EPMs as shark deterrent technology during commercial fishing. The Pacific Islands Fisheries Science Center of the National Marine Fisheries Service, Honolulu, Hi. hosted a Shark Deterrent and Incidental Capture Workshop on Apr. 11, 2008 at the New England Aquarium, Boston, Mass. Researchers were invited to present on a variety of topics, including shark sensory biology, an overview of shark bycatch during pelagic longline fishing and an arsenal of shark deterring technologies offered by Shark Defense. The majority of the research presentations focused on the effects of EPMs on shark behavior and presented evidence on their efficacy as a shark bycatch reduction mechanism during commercial fishing. The following outline the major results presented during the workshop:

Wang, Swimmer, and McNaughton (2008) reported repelling behavior of Galapagos (C. galapagensis) and sandbar (C. plumbeus) sharks when an EPM (Neodymium-Praseodymium mischmetal; NdPr) was placed on the end of a baited bamboo pole in preliminary studies in Hawaiian waters.

Stoner and Kaimmer (2007) conducted laboratory investigations on the effects of EPMs on spiny dogfish (S. acanthias) and Pacific halibut (Hippoglossus stenolepis). In a pairwise test with EPMs and inert metal controls, they reported that dogfish attacked and consumed baits protected with cerium (Ce) mischmetal at a significantly lower frequency than controls. Number of approaches before attacking the bait and time to attack the baits was significantly higher in the presence of mischmetal, as were numbers of approaches before first attack. No halibut aversion was reported. Encouraged by the results of the laboratory studies, Kaimmer and Stoner (2008) conducted field investigations using EPMs as a deterrent during commercial fishing for halibut near Homer, Ak. They reported a 17% reduction in spiny dogfish bycatch and a 48% reduction in bycatch of the clearnose skate—another elasmobranch with ampullae of Lorenzini electroreception abilities. They reported no noticeable aversion by the halibut and an associated 5% increase in halibut catch. Increases in halibut catch were most likely due to more hooks available to target species. Stoner and Kaimmer also conducted additional cerium mischmetal EPM trials during 2008 at the Oregon Coastal Aquarium (Newport, Oreg.) to observe the behavior of sharks in the presents of EPMs and lead controls suspended in the water column. Analysis of the video suggested that several species of sharks and rays avoided the EPM more than the lead control.

Brill et al., (2009) conducted EPM trials using small sandbar sharks (C. plumbeus) in a 3.6 m diameter×0.67 m deep pool. The experimental design consisted of an EPM treatment—three small ingots of NdPr mischmetal suspended in a vertical line immediately below the water surface—and a control—three small lead ingots of similar size and shape and similarly suspended in the water column—placed into the tank with the captive sharks. Their swimming patterns were recorded over one hour intervals and were subsequently digitized using Lolitrack automated video analysis software (Loligo Systems, Tjele, Denmark). They suggested that the NdPr mischmetal clearly exhibited potential to repel sharks and hand potential for reduction of shark bycatch during commercial longline fishing.

Brill (2009) also reported that in field trials with bottom longline gear, electropositive metal placed within 10 cm of the hooks reduced the catch of sandbar sharks by approximately two thirds, compared to the catch of sharks on hooks in proximity to plastic pieces of similar size and shape.

Although two 2008 studies involving spiny dogfish were inconclusive, the consensus of the workshop participants was that EPMs were a potential practical and promising shark deterrent technology for application in commercial fisheries.

While ferromagnets and electropositive metals alone have both demonstrated shark repellency, species-specific behavioral variations have been reported by fishermen using these single materials (e.g., some sharks responded only to magnets and not to metals). For example, in 2008 field studies where spiny dogfish (Squalus acanthias) represent a large component of unwanted catch, Pacific spiny dogfish were repelled by electropositive metals (Stoner, Kaimmer, 2008), while Atlantic spiny dogfish were not (Tallack, Mandelman, 2009). Brown smooth hound sharks (Mustelis henlei) in Baja, Mexico were responsive to magnets but not to electropositive metals. (J. Wang, pers. comm.). In a 2008 International Pacific Halibut Commission field study, unwanted catch of Pacific longnose skates was reduced 48% using electropositive metals (Stoner, 2008), while catch rates remained unaffected for Atlantic butterfly rays and southern stingrays (Dasyatis americana) using electropositive metals (Brill, 2009), yet southern stingrays in both the Florida Keys and South Bimini, Bahamas (D. americana) were responsive to permanent magnets (O'Connell, 2007, 2008, 2009). Current magnetic materials that combine electropositive metals and ferromagnetic metals, such as neodymium-iron-boride (NIB) and samarium-cobalt (SmCo) magnets, are unsuitable for commercial fishery use. NIB magnets are readily corroded by seawater due to the high iron content in its sinter. SmCo magnets offer better corrosion resistance but are brittle and are more expensive compared to ferrite materials.

The storage and deployment of the aforementioned shark repellent materials add additional challenges for fishermen. These materials must be stored onboard the vessel, and add to the expense when gear is lost due to shark interactions. During deployment, each magnetic or electropositive repellent device must be secured to a gangion, adding labor and time to the fishing effort. Storing hundreds of powerful NIB or SmCo magnets in close proximity onboard of a metal fishing vessel is not practical. These magnetic materials produce fluxes in excess of 1,000 Gauss, readily attracting other nearby magnetic metals. A lower flux magnetic material that maintains shark repellency is required.

A demersal longline study was conducted by Coastal Carolina University during the summer of 2008 at Winyah Bay, S.C. using magnetized hooks ranging from 40 gauss to 80 gauss (much weaker than powerful rare earth magnets). The results of this study were compared to magnet-on-hook trials at the same location. A significantly lower number of sharks were captured using magnetized hooks than with the magnet-on-hook design (χ2=4.50, d.f.=1, p=0.0339). While magnet-on-hook trials significantly reduced the chances of capturing a shark by half (χ2=4.545, d.f.=1, p=0.0330), sharks were repelled from ALL hooks in the magnetized hook trials. The researchers recognized a temporal variation existed between longline studies, and therefore conducted tonic immobility trials with five juvenile lemon sharks (Negaprion brevirostris). Using magnetized hooks (54 gauss), all five subjects violently roused and terminated immobility when the magnetized hook was presented.

In summary, a fishing hook with magnetic flux ranging from 5 to 80 Gauss and an electropositive coating is commercially desirable, as this would reduce attraction to other metals and tackle while maintaining shark repellency and high selectivity towards target catch.

### DETAILED DESCRIPTION OF THE INVENTION

“By-catch” is any kind of fish that is caught in a fishing operation wherein the catching of the fish is not the object of the fishing operation. For example, if the target fish of a longline fishing operation is tuna, an elasmobranch caught on a hook of the longline is by-catch.

“Elasmobranchs” in this specification means one or more elasmobranchii in the super-orders Galeomorphii and Squalomorphii and orders Squaliforms (dogfish), Carcharhiniformes (requiem sharks), Lamniformes (mackerel sharks), and Orectolobiformes (carpet sharks).

“Electropositive” in this specification means possessing a revised Pauling electronegativity of less than 1.3. Examples of an electropositive metal suitable for use in the present invention are a Lanthanide (also referred to as Lanthanoid) metal, a Group 1 metal, a Group II metal, a Group III metal, Magnesium metal, or an alloy of electropositive metals.

“Ferromagnetic” in this specification means capable of retaining a magnetic characteristic after exposure to another magnetic field. Alloys of iron, cobalt, and many steels possess this property. Within ferromagnetic materials, the spin of unpaired electrons are aligned in the same direction. Also, a greater-than-average number of magnetic domains containing these aligned electrons are also aligned in the same direction, creating a net moment. This moment creates the familiar “north” and “south” poles of a permanent magnet or a ferromagnetic material.

“Gauss” is a measure of magnetic field strength. Gauss is a unit of the density of a magnet's flux (or flux density) measured in centimeter-gram-second. A tesla is equal to 10,000 gauss. Gauss and tesla are common units for referring to the power of a magnet to attract (or repel) other magnets or magnetic materials. The Gauss unit describes both the coercivity of a magnet and its saturation magnetization. Gauss describes how strong the magnetic fields are extending from the magnet and how strong of a magnetic field it would take to de-magnetize the magnet.

“Grade” of a neodymium-iron-boride magnet specifies the quality of material used to construct the magnet. All else being equal, the higher the quality of materials used to construct the magnet, the greater the magnet's strength. In grading neodymium-iron-boride magnets, a lower grade, e.g., N35 does not have as much magnetic strength as a higher grade, e.g. N45.

“Hook” in this specification refers to a metal fishing hook for marine use. Fishing hooks are further divided into specialized shapes depending on the type of prey sought, such as circle hooks, J-hooks, and treble hooks. The metals used in the manufacture a fishing hook typically include steel or stainless steel, and optionally include cadium, tin, zinc, gold, or nickel platings.

“Pull force” is the attractiveness of a magnet to a mild steel flat surface in pounds. The formula for calculating pull force is provided in detail herein.

“Target fish” is any kind of fish, the catching of which is the object of a fishing operation. For example, the target fish of a longline fishing operation may be tuna. A fish that is caught on the longline that is not tuna would not be a target fish.

“Tonic immobility” is the state of paralysis that typically occurs when an elasmobranch is subject to inversion of its body along the longitudinal axis of the body, i.e., is belly up. An elasmobranch can remain in this state for up to 15 minutes.

While not wishing to be bound to a specific physiological mechanism, the inventor hypothesizes that weakly magnetized materials are capable of repelling elasmobranchs more efficiently than high pull force magnets. In recent experimentation with captive juvenile lemon sharks (N. brevirostris) and free-swimming blacktip sharks (C. limbatus) magnetic fluxes of 0.6 gauss to 100 gauss measured at the hook were effective in reducing shark captures when compared to nonmagnetized control hooks. The inventors hypothesize that very high pull force magnets, particularly grade N38 and higher neodymium-iron-boride magnets, may be too strong to achieve consistent repellency with elasmobranchs. For example, rare earth magnets are capable of producing thousands of gauss near their surfaces. This is thousands of times greater than the Earth's geomagnetic signature that is observed around 500 milligauss. The presence of an overly powerful permanent magnetic flux may be so “unnatural” to an elasmobranch's ampullary organ that the organ does not register the effect at all, or nullifies it rather than produce an aversion signal. In contrast, a weakly magnetized steel fishing hook may only produce 100 gauss at its surface, and this is only 200 times stronger than the Earth's geomagnetic signature. This effect was observed using the tonic immobility bioassay with juvenile lemon sharks (N. brevirostris). The sharks terminated tonic immobility more often when weakly magnetized hooks were presented versus powerful rare earth magnets.

The strength of the magnetic flux decreases with the inverse cube of the distance from the magnetized hooks surface. A shark would experience less than 10 gauss only a few inches from the magnetized hook.

Cobalt and Iron are examples of ferromagnetic elements at room temperature. Steel, low-austenitic stainless steels, Samarium-Cobalt, Sendust, Neodymium-Iron-Boride, Permalloy, Supermalloy, Alnico, Bismanol, CuNiFe, Heusler alloy, and Fernico are examples of room-temperature ferromagnetic alloys. Some ferromagnetic materials, are strong enough to be used directly as a fishing hook. Steel and 400-series stainless steels are examples of materials suitable for use as the entire fishing hook. Soft alloys, such as Bismanol, do not possess this structural integrity and therefore are more useful as a coating or external treatment on an existing fishing hook.

A nonmagnetized ferromagnetic hook is made magnetic by exposing the hook to another permanent magnet or an energized electromagnet. Preferably, the nonmagnetized hook is placed in physical contact with a permanent magnet, such as a Barium-ferrite ceramic magnet. A nonmagnetized ferromagnetic hook may also be magnetized by placing it in close proximity to an electrified coil, commonly found on electromagnets. The magnetization process is nearly instantaneous and is reversible by heating above the Curie temperature, repeated mechanical shock, or degaussing equipment.

Weakly magnetized hooks are also desirable to fishermen for four reasons. First, in many commercial fisheries, sharks comprise a significant portion of by-catch. More by-catch equates to less target fish and potential loss of income and tackle. For this reason, it is very desirable for fishermen to have a shark by-catch reduction device which does not affect the target fish. Permanent magnets fulfill this requirement. Secondly, there is no additional tackle in the form of permanent magnets to store and rig onboard a moving metallic vessel. The present invention saves storage space and reduces vessel weight. Third, since the hook is only weakly magnetized, the tendency for the hooks to entangle and attach to other metal surfaces is greatly reduced. This makes handling magnetized metals on a metal vessel much easier than having a plurality of permanent magnets to contend with.

Finally, if a ferromagnetic fishing hook, such as a steel circle hook, is used, there is no significant additional expense to the fishermen to magnetize the hook other than their time. This eliminates the expense of purchasing permanent magnets to achieve the same effect.

The second component of the magnetoelectropositive hook incorporates the use of an electropositive metal on or within the hook material. The pure metal (ground state) form of Praseodymium, Neodymium, Cerium, Samarium, Ytterbium, or Magnesium metal is particularly effective at inducing aversive behavioral responses in juvenile sharks. For reasons not yet fully understood, elasmobranchs, particularly those of the order Carcharhiniformes, exhibit aversive behavior within a 0.2 meter range of these electropositive metals.

We first observed the unusual repellent effects of Lanthanide metals on sharks when tonically-immobilized juvenile lemon sharks (N. brevirostris) exhibited violent rousing behavior in the presence of a 153 gram 99.95% Samarium metal ingot. As the Samarium metal was moved towards the immobilized shark, the shark terminated tonic immobility, in the direction away from the approaching metal. For experimental controls, pure Chromium, an antiferromagnetic metal, and pyrolytic graphite, a highly diamagnetic substance, failed to produce any behavioral responses in juvenile lemon sharks.

Next, a polystyrene white plastic blinder was used to remove any visual and motion cues from an approaching metal. This blinder was placed close to the shark's eye, sufficiently shielding its nares, eyes, gills, and head up to its pectoral fin. Again, Samarium metal terminated tonic immobility in all test subjects at a range of 2 to 50 cm from the blinder. Chromium metal and pyrolytic graphite did not produce any notable behavioral shifts.

In order to confirm that pressure waves were not affecting the test subjects, the tester's hand was moved underwater towards the shark's head both with and without blinders at varying speeds. This motion also did not disrupt the immobilized state.

The same series of experiments were repeated with juvenile nurse sharks (G. cirratum) and yielded the same behavioral results.

The same experimental protocol was repeated with a 73 gram ingot of 99.5% Gadolinium metal and yielded the same behavioral results in both juvenile lemon sharks and nurse sharks. It is noted that the rousing behavior was most violent when Samarium metal was used. Additionally, the Gadolinium metal corroded quickly after seawater exposure, and therefore would be appropriate for a one-time use application.

Next, in order to eliminate the possibility of galvanic cell effects, juvenile sharks were removed from their pens and brought at least 15 meters away from any submerged metal objects. All testers and witnesses removed watches, rings, and jewelry so that only the lanthanide metal was exposed to seawater. The same experimental method was repeated in lemon sharks and we report that tonic immobility was terminated with Samarium metal in all tests.

We report that waving Samarium or Gadolinium in air above immobilized or resting sharks does not effect behavior, even when the metal is very close to the water's surface. The metal must be in contact with seawater in order to produce the repellent effect. This is notably different from the effects of a rare-earth magnet, which will often terminate tonic immobility at close range in air. It is thus proposed that any electropositive metal or alloy must be in contact with the seawater to produce the desired repellency effect.

The effects of lanthanide metal on free-swimming sharks were also evaluated. Two juvenile nurse sharks (less than 150 cm total length) were allowed to rest in an open-water captive pen. The tester approached the nurse sharks and moved his hand near the pen wall. His hand contained no metal. Both nurse sharks remained at rest. Next, the tester presented the 153 gram ingot of Samarium metal underwater to the pen wall and we note that both nurse sharks awakened and rapidly swam away from the tester's locale.

Next, a highly-stimulated competitively-feeding population of six blacknose sharks (C. acronotus) (total length up to 120 cm) and six Carribean reef sharks (C. perezii) (total length up to 210 cm) was established using chum and fish meat. A diver entered the water near the population of sharks with the 153 gram of Samarium metal secured to one end of a 1.5 meter-long polyvinyl chloride pole. As free-swimming sharks swam close to the diver, the control end of the pole (without metal) was presented in a left-right waving motion. Approaching sharks would swim past, bump, or briefly bite the pole. The diver then turned the Samarium metal-end of the pole towards the approaching sharks. All blacknose sharks exhibited a “twitching” or “jerking” behavior as they came near the metal ingot and quickly swam away. Caribbean reef sharks generally avoided the metal, but did not exhibit the twitching behavior.

Some pure Lanthanide metals are extremely reactive to air and water, and therefore are not particularly well-suited for long time use in the marine environment. For example, pure Europium metal has been observed to appreciably oxidize in air in a matter of hours and degrades quickly in moist air. Other metals, such as Erbium and Samarium have a much higher resistance to oxidation in air and slowly react with cold seawater. Other reactive pure Lanthanide metals are acceptable for one-time use as long as they are kept protected prior to use.

Mixtures and alloys containing Lanthanide metals may serve as an economical alternative to pure Lanthanide metals. In particular, Cerium Misch metal, Lanthanum Misch metal, Neodymium-Praseodymium Misch metal and Samarium-Cobalt (SmCo) mixtures and alloys may be used in shark-repelling devices.

It is not yet fully understood why sharks are responding to Lanthanide metals. It would seem that some type of detection is occurring in the Ampullae of Lorenzini organ, but how electrical currents are being generated and detected with a solitary rare earth metal in seawater is not known at this time. We hypothesized that a magnetic or electrical field was being induced by the metal's movement through seawater. We attempted to measure minute magnetic fields being produced by the movement of Samarium metal through seawater in a closed system. A submersible calibrated milliGauss meter probe was secured in a plastic tank containing seawater with the same salinity, pH, and temperature of the water used in previous shark testing. After zeroing out the Earth's magnetic field, we did not detect any magnetic fields being produced by the movement of Samarium metal through the tank, within tenths of a milliGauss. Because there appears to be a lack of a magnetic field component, there cannot be an electrical field component. This is a difficult concept because the sharks are responding, at most times violently, only when the metal is in contact with seawater. The same phenomenon occurs when the sharks are far-removed from any other pure metals or alloys in seawater.

The effect is not limiting to the order of the shark, as both nurse sharks (Orectolobiformes) and lemon sharks (Carcarhiniformes) responded in a similar manner.

Another hypothesis is that water-soluble salts are being formed and driven towards the shark as the metal is moved through seawater. The shark, in turn, may be hypersensitive to the presence of rare-earth compounds or ions. The use of our blinder during the experiments should have steered any water containing rare earth salts around the shark's nose and mouth, limiting exposure, but the response was equal with or without blinders. In one test, an immobilized shark was moved towards a stationary Samarium ingot. The shark exhibited bending away from the ingot prior to terminating immobility. This movement would have pushed metal salts away from the shark.

Further experiments using solutions of the nitrates and chlorides of the early-Lanthanide metals showed no behavioral shifts (using seawater controls) when presented to immobilized sharks at doses up to 25 mL to the nares.

Captive Cobia, which are commercially valuable marine fish, were exposed to Lanthanide metals during feeding trials. We report that exposure to Holmium, Gadolinium, Dysprosium, and Samarium ingots did not disrupt normal feeding behavior. Cobia do not possess the Ampullae of Lorenzini organ found in sharks.

A close correlation was found between the revised Pauling electronegativity values for these metals, and behavioral response. As the revised Pauling electronegativity decreased, the violence of the response seemed to increase. A repellency threshold was found at an electronegativity of 1.3 or less—Metals with electronegativities greater than 1.3 did not produce the response. Highly reactive metals, such as Strontium and Calcium (electronegativities of 0.89 and 1.00 respectively) produced a rousing reaction as expected.

### EMBODIMENTS

The present invention combines the repellent effects of ferromagnetism along with electropositivity to offer two shark repellents within a standard metal fishing hook. In one embodiment of the invention, an electropositive metal is incorporated onto the hook by wrapping a ribbon, foil, or sheet of the metal around a portion, portions, or the entire magnetized hook. In another embodiment of the invention, a coating of electropositive metal is deposited onto a portion, portions, or the entire magnetized exterior hook surface through sputtering, thermal evaporation, thick-film deposition, or chemical vapor deposition techniques. In a third non-limiting embodiment of the invention, an electropositive metal or an alloy of electropositive metals is combined with gallium metal to produce a low-melting point alloy. The gallium-electropositive metal alloy is warmed to its melting point and applied to a portion, portions, or the entire surface of a cleaned and magnetized hook. Upon cooling, an electropositive coating remains at the application site of the magnetized hook. In yet another non-limiting embodiment of the invention, a hook is made directly from a ferromagnetic alloy that also contains one or more electropositive metals. This alloy would ideally have a mechanical strength and machinability comparable to standard fishing hooks.

### INDUSTRIAL APPLICATION

The present invention finds use in commercial fisheries where unintentional shark by-catch is a problem. The use of magneto-electropositive fishing hooks reduces the number of sharks captured on hook and therefore makes these hooks available for target fish. The magneto-electropositive hook is particularly useful in tuna and swordfish fisheries.

### REFERENCES

NOAA Fisheries, National Marine Fisheries Service, 2004. Profile: The Atlantic pelagic longline fleet. Northeast Distant Fishery Sea Turtle Bycatch Reduction Fact Sheet. Available online: www.nmfs.noaa.gov/mediacenter/turtles/docs/pelagic_longlining.pdf

Gilman, E., Clarke, S., Brothers, N., Alfaro-Shigueto-J., Mandelman, J., Mangel, J., Petersen, S., Piovano, S., Thomson, N., Dalzell, P., Donoso, M., Goren, M., Werner, T. 2007. Shark depredation and unwanted bycatch in pelagic longline fisheries: Industry practices and attitudes, and shark avoidance strategies. Western Pacific Regional Fishery Management Council.

Kalmijn A. 1973. Electro-orientation in sharks and rays: Theory and experimental evidence. Scripps Institute of Oceanography, manuscript. 73-39.

Kalmijn, A. J. 1974. The detection of electric fields from inanimate and animate sources other than electric organs. Handbook of Sensory Physiology (ed. A. E. Fessard), 147-200.

Kalmijn A. 1982. Electric and magnetic field detection in elasmobranch fishes. Science. 218:916-918.

Kalmijn A. 1984. Theory of electromagnetic orientation: a further analysis. In: Bolis L, Keynes R D, Maddrell S H P, editors. Comparative physiology of sensory systems. Cambridge, UK: Cambridge Univ Press. p 525-560.

Phillips, J. B. 1996. Magnetic navigation. J. Theor. Biol 180:309-319.

Carey, F. G., Scharold, J. V. 1990. Movements of blue sharks (Prionace glauca) in depth and course. Mar. Biol. 106:329-342.

Klimley, A. P. 1993. Highly directional swimming by the scalloped hammerhead sharks, Sphyrna lewini, and subsurface irradiance, temperature, bathymetry, and geomagnetic field. Mar. Biol. 117: 1-22.

Wiltschko, R., Wiltschko, W. 1995a. Magnetic orientation in animals. Springer-Verlag, Frankfurt.

Holland, K. N; Wetherbee, B. M; Lowe, C. G; Meyer, C. G. 1999. Movements of tiger sharks (Galeocerdo cuvier) in coastal Hawaiian waters. Mar. Biol. 134:665-673.

Skiles, D. D. 1985. The geomagnetic field: Its nature, history, and biological relevance. In J. L. Kirschvink, D. S. Jones, and B. J. MacFadden (eds.), Magnetite biomineralization and magnetoreception in organisms: A new biomagnetism, pp. 4-102. Plenum Press, New York.

Kirschvink, J. L., Walker, M. M., Diebel, C. E. 2001. Magnetite-based magnetoreception. Curr Opin Neurobiol 11: 462-467.

Wiltschko, W., Munro, U., Wiltschko, R, Kirschvink, J. L. 2002. Magnetite-based magnetoreception in birds: The effect of a biasing field and a pulse on migratory behavior. J Exp Biol 205: 3031-3037.

Ritz, T., Adem S., Schulten, K. 2000. A model for photoreceptor-based magnetoreception in birds. Biophys. J 78:707-718.

Johnsen, S., Lohmann, K. J. 2005. The physics and neurobiology of magnetoreception. Nature Rev. Neurosci. 6,703 -712.

Kalmijn, A. J. 1966. Electro-perception in sharks and rays. Nature (Lond.) 212:1232-1233.

Kalmijn, A. J. 1971. The electric sense of sharks and rays. J. Exp. Biol. 55:371-383.

Meyer, C. G., Holland, K. M., Papastamatiou, Y. P. 2005. Sharks can detect changes in the geomagnetic field. J R Soc Interface. March 22; 2(2): 129-130.

Kajiura, S. M., Holland, K. N. 2002. Electroreception in juvenile scalloped hammerhead and sandbar sharks. J. Exp. Biol. 205:3609-3621.

Kajiura, S. M. 2003. Electroreception in neonatal bonnethead sharks, Sphyrna tiburo Mar. Biol. 143: 603-61.

Peters, R. C., Eeuwes, L. B., Bretschneider, F. 2007. On the electrodetection threshold of aquatic vertebrates with ampullary or mucous gland electroreceptor organs. Biological Reviews 82(3): 361-373.

O'Connell, C. P., Stroud, E. M., Herrmann, M., Rice, P. H., Gruber, S. 2007.Evaluation of barium-rerrite permanent magnets on the behavior of four Species of elasmobranchs. As presented to the American Elasmobranch Society, Jul. 15.

O'Connell, C. P. 2008. Shark Deterrent and Incidental Capture Workshop, Apr. 10-11, 2008. U.S. Dep. Commer., NOAA Tech. Memo. NOAA-TM-NMFS-TM-PIFSC-16, 48-50.

O'Connell, C. P., Rice, P. H., Stroud, E. M., Abel, D. C., Simuro, N. 2009. Effectiveness of barium ferrite permanent magnets on the feeding behavior of elasmobranchs. As presented to the American Fisheries Society, South Carolina chapter, Feb. 13.

Stroud, E. M. United States patent application 20070256623 (May 7, 2007).

Stroud, E. M. Canadian patent application 2,598,148 (May 7, 2007).

Stroud, E. M. U.S. provisional patent application 61/275,684 (Sep. 24, 2008).

A. J. Bard, R. Parsons, and J. Jordan, Standard Potentials in Aqueous Solutions, IUPAC (Marcel Dekker), New York, USA, 1985.

Swimmer, Y., Wang, J. H., McNaughton, L. 2008. Shark Deterrent and Incidental Capture Workshop, Apr. 10-11, 2008. U.S. Dep. Commer., NOAA Tech. Memo. NOAA-TMNMFS-TM-PIFSC-16, iii.

Wang, J. H., Swimmer, Y., McNaughton, L. 2008. Shark Deterrent and Incidental Capture Workshop, Apr. 10-11, 2008. U.S. Dep. Commer., NOAA Tech. Memo. NOAA-TMNMFS-TM-PIFSC-16, 28-32.

Stoner A. W., Kaimmer, S. M. 2008. Reducing elasmobranch bycatch: Laboratory investigation of rare earth metal and magnetic deterrents with spiny dogfish and Pacific halibut. Fisheries Research 92(2-3), 162-168.

Kaimmer, S. M., Stoner, A. W. 2008. Shark Deterrent and Incidental Capture Workshop, Apr. 10-11, 2008. U.S. Dep. Commer., NOAA Tech. Memo. NOAA-TM-NMFS-TMPIFSC-16, 64-66.

Stoner, A. W., Kaimmer, S. M. 2008. Shark Deterrent and Incidental Capture Workshop, Apr. 10-11, 2008. U.S. Dep. Commer., NOAA Tech. Memo. NOAA-TM-NMFS-TMPIFSC-16, 60-63.

Brill, R., Bushnell, P., Smith, L., Speaks, C., Sundaram, R., Stroud, E., Wang, J. 2009. The repulsive and feeding deterrent effects of electropositive metals on juvenile sandbar sharks (Carcharhinus plumbeus). In press, Fisheries Bulletin. FB-3298.

Tallack, S. M. L., Mandelman, J. W. 2009. Do rare-earth metals deter spiny dogfish? A feasibility study on the use of electropositive “mischmetal” to reduce the bycatch of Squalus acanthias by hook gear in the Gulf of Maine. ICES Journal of Marine Science. 66: 315-322.

O'Connell, C. P., Rice, P. H., Stroud, E. M., Abel, D. C., Simuro, N. C. The Effects of Permanent Magnets on the Southern Stingray (Dasyatis americana) and the Nurse Shark (Ginglymostoma cirratum). Marine and Freshwater Behavior and Physiology, April 2010.

### PENDING PATENT REFERENCES

U.S. patent application Ser. No. 11/800,545, “ELASMOBRANCH-REPELLING ELECTROPOSITIVE METALS NAD METHODS OF USE”

U.S. patent application Ser. No. 11/886,109, “ELASMOBRANCH-REPELLING MAGNETS AND METHODS OF USE”

What is claimed is:

1. A fishing hook, magnetized to emit a permanent magnetic flux of at least 5 gauss at a distance of 0.01 meters, and containing an exterior coating of an electropositive metal whose Pauling electronegativity is less than 1.33.

2. Fishing hook in claim 1 is comprised of steel, stainless steel, or carbon steel.

3. Fishing hook in claim 1 is magnetized using contact magnetization or impulse magnetization.

4. Electropositive metal in claim 1 is selected from the group consisting of Lanthanum, Cerium, Praseodymium, Neodymium, Samarium, Europium, Gadolinium, Terbium, Dysprosium, Holmium, Erbium, Thulium, Ytterbium, Lutetium, Yttrium, Scandium, Hafnium, Magnesium, Calcium, Strontium, Lithium, Cerium Mischmetal, Neodymium-Praseodymium Mischmetal, Neodymium-Praseodymium alloy, Ferrocerium, Lanthanum Mischmetal, separately or in combination.

5. Electropositive metal in claim 1 produces at least 0.5 volts of electromotive force relative to a carbon electrode in seawater electrolyte at pH 8.1 with an electrode spacing of at least 0.01 meters.

6. Exterior coating in claim 1 is a ribbon, foil, wire, or sheet of electropositive metal applied to the fishing hook.

7. Exterior coating in claim 1 is an electropositive metal that is wrapped, sputtered, thermally evaporated, or electrochemically deposited onto the hook.
